(19) United States
(12) Patent Application Publication
(10) Pub. No.: US 2023/0236456 A1
(43) Pub. Date: Jul. 27, 2023

(54) DISPLAY DEVICE AND IN-VEHICLE DISPLAY DEVICE

(71) Applicant: Panasonic Intellectual Property Management Co., Ltd., Osaka (JP)

(72) Inventor: Norihito KITAJIMA, KANAGAWA KEN (JP)

(73) Assignee: Panasonic Intellectual Property Management Co., Ltd., Osaka (JP)

(21) Appl. No.: 18/074,030

(22) Filed: Dec. 2, 2022

(30) Foreign Application Priority Data
Jan. 27, 2022 (JP) 2022-011266

(51) Int. Cl. G02F 1/1335; G02F 1/1333; B60R 1/22; B60R 11/02

(52) U.S. Cl. CPC G02F 1/133536; B60R 1/22; B60R 11/0235; G02F 1/133308; G02F 1/133553; G02F 1/1323

(57) ABSTRACT

A display device includes a cover, a display, and a polarization reflection layer. The cover transmits visible light. The display displays an image. The polarization reflection layer is disposed between the cover and the display and on a surface of the display. The polarization reflection layer reflects part of light incident through the cover and transmits light of the image displayed by the display.

### CROSS-REFERENCE TO RELATED APPLICATIONS

This application is based upon and claims the benefit of priority from Japanese Patent Application No. 2022-011266, filed on Jan. 27, 2022, the entire contents of which are incorporated herein by reference.

### FIELD

The present disclosure relates generally to a display device and an in-vehicle display device.

### BACKGROUND

There has been conventionally disclosed a vehicle image display function-equipped mirror that reflects part of incident light and transmits light of a display device housed inside (for example, JP 2017-111267 A). The image display function-equipped mirror may include a polarization reflection layer and a polarization plate. The polarization reflection layer reflects part of incident light and transmits light of a display device housed inside. The polarization reflection layer and the polarization plate overlap in the respective roles of polarizing light.

However, it is preferable to resolve the overlap of roles in order to, for example, reduce the number of parts to lower the cost. Therefore, there is a demand for a technique capable of resolving the overlap of roles among plural structural members.

### SUMMARY

A display device according to one aspect of the present disclosure includes a cover, a display, and a polarization reflection layer. The cover is configured to transmit visible light. The display is configured to display an image. The polarization reflection layer is disposed between the cover and the display and on a surface of the display. The polarization reflection layer is configured to reflect part of light incident through the cover and transmit light of the image displayed by the display.

### BRIEF DESCRIPTION OF THE DRAWINGS

FIG. 1 is a front view illustrating an example of an electronic mirror according to a first embodiment;

FIG. 2 is an exploded perspective view illustrating an example of the electronic mirror according to the first embodiment;

FIG. 3 is a cross-sectional view of A-A for the electronic mirror illustrated in FIG. 1;

FIG. 4 is an exploded perspective view illustrating an example of an electronic mirror according to a second embodiment;

FIG. 5 is a cross-sectional view of the electronic mirror according to the second embodiment;

FIG. 6 is an exploded perspective view illustrating an example of an electronic mirror according to a third embodiment;

FIG. 7 is a cross-sectional view of the electronic mirror according to the third embodiment;

FIG. 8 is a front view illustrating an example of an electronic mirror according to a fourth embodiment;

FIG. 9 is an exploded perspective view illustrating an example of the electronic mirror according to the fourth embodiment; and

FIG. 10 is a cross-sectional view of A-A for the electronic mirror illustrated in FIG. 8.

### DETAILED DESCRIPTION

Hereinafter, embodiments of the present disclosure will be described in detail with reference to the drawings as appropriate. Note that unnecessarily detailed description may be omitted. Note that the attached drawings and the following description are provided for a person skilled in the art to fully understand the present disclosure, and are not intended to limit the subject matter described in the claims.

### First Embodiment

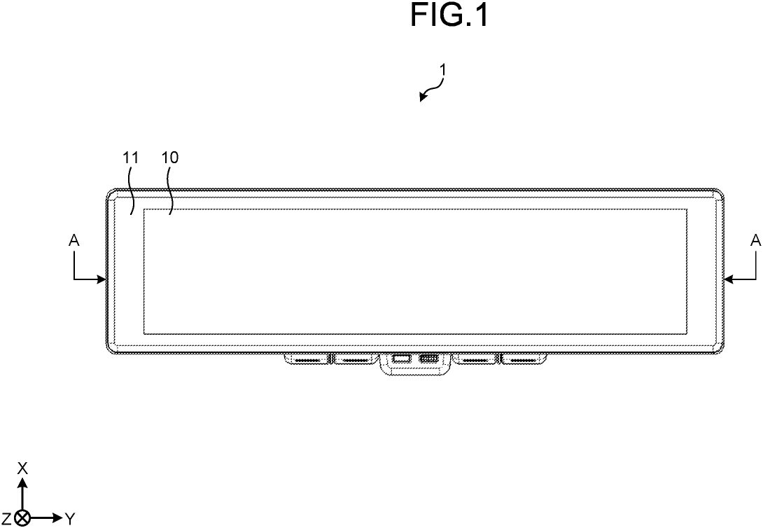

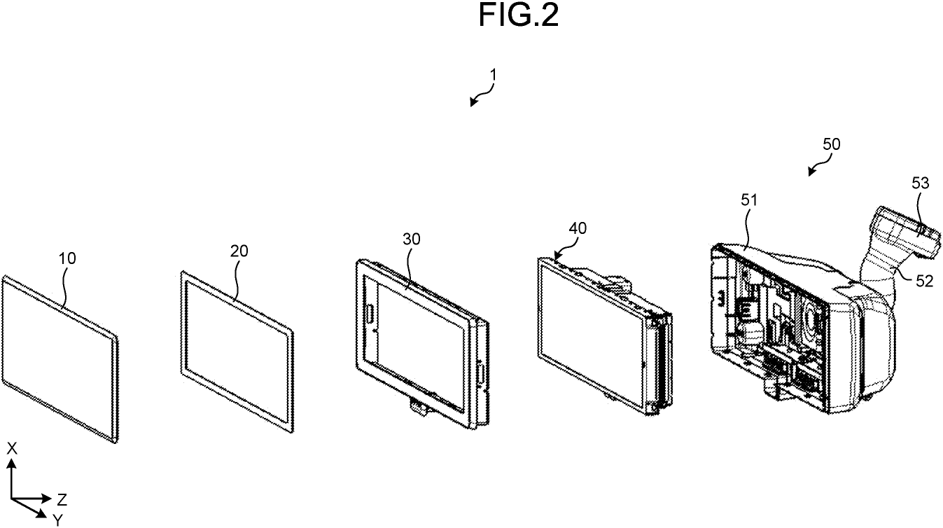

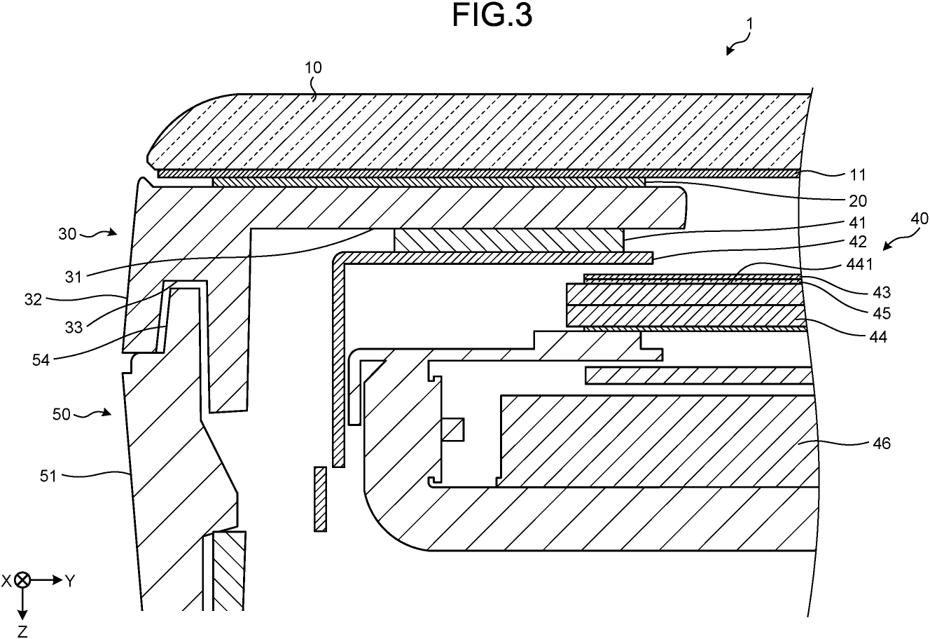

FIG. 1 is a front view illustrating an example of an electronic mirror 1 according to a first embodiment. FIG. 2 is an exploded perspective view illustrating an example of the electronic mirror 1 according to the first embodiment. FIG. 3 is a cross-sectional view of A-A for the electronic mirror 1 illustrated in FIG. 1. Note that a width direction of the electronic mirror 1 is defined as an X-axis direction, a height direction of the electronic mirror 1 is defined as a Y-axis direction, and a depth direction of the electronic mirror 1 is defined as a Z-axis direction. In addition, in the electronic mirror 1, a side on which an image is displayed is defined as a front side, and a side opposite to the front side is defined as a rear side.

The electronic mirror 1 is, for example, an electronic inner mirror disposed in the interior of a vehicle. The electronic mirror 1 functions as a display device and a mirror. Specifically, when functioning as a display device, the electronic mirror 1 displays an image captured by a camera serving to capture an image behind the vehicle. When functioning as a mirror, the electronic mirror 1 projects an image behind the vehicle by reflecting light. The electronic mirror 1 is an example of a display device and an in-vehicle display device.

The electronic mirror 1 has a display mode functioning as a display device and a mirror mode functioning as a mirror. The display mode is a mode that the electronic mirror 1 displays an image captured by a camera serving to capture an image behind the vehicle. The mirror mode is a mode that the electronic mirror 1 projects an image behind the vehicle by reflecting light incident on the electronic mirror 1. The electronic mirror 1 switches between the display mode and the mirror mode by, for example, receiving operation performed by using a lever or the like.

As illustrated in FIG. 2, the electronic mirror 1 includes a cover lens 10, a double-sided tape 20, a frame 30, a display 40, and a housing 50. The cover lens 10 is a cover that transmits visible light. More specifically, the cover lens 10 is made from a transparent member and formed to cover a front of the electronic mirror 1. The cover lens 10 is made from resin, for example. The cover lens 10 may be made from glass. By being made from resin, the cover lens 10 is reduced in weight in comparison with the cover lens 10 made from glass.

Additionally, the cover lens 10 includes a mirror layer 11 that projects an image at a position corresponding to the frame 30 by reflecting visible light. The position corresponding to the frame 30 refers to a position at least part of which overlaps with the frame 30 when the electronic mirror 1 is viewed from the front. The mirror layer 11 may be configured to overlap with the whole of the frame 30 or exceed the frame 30 when the electronic mirror 1 is viewed from the front. The mirror layer 11 is a portion where incident light is reflected by a silver film which is formed to have a mirror surface. With this structure, the mirror layer 11 projects an image like a mirror does. The cover lens 10 is transparent, so that a member on a rear side of the cover lens 10 may be visually recognized through the cover lens 10. The member on the rear side is, for example, the double-sided tape 20 or the frame 30 described later. By providing the mirror layer 11 on the cover lens 10, the mirror layer 11 can project an image behind the vehicle while hiding the double-sided tape 20 and the frame 30. Therefore, when the mirror mode is selected, the entire surface of the electronic mirror 1 can become a mirror.

The double-sided tape 20 is a tape whose both surfaces are coated with adhesive. The double-sided tape 20 causes the cover lens 10 and the frame 30 to adhere to each other.

The frame 30 is an outer frame that is joined to the housing 50 and covers an edge of the display 40. In addition, the frame 30 supports the cover lens 10. The frame 30 supports the cover lens 10 by, for example, being attached with the double-sided tape 20.

Moreover, the frame 30 includes an outer frame part 31 and a joint part 32. The outer frame part 31 covers an edge of the display 40. The joint part 32 is joined to the housing 50. The outer frame part 31 includes a planar plate that is substantially parallel to a liquid crystal display (LCD) cell 44 included in the display 40 and covers an edge of the display 40. The joint part 32 includes a recess part 33 into which a protrusion 54 of the housing 50 is inserted. The joint part 32 is joined to the housing 50 by inserting the protrusion 54 into the recess part 33.

The display 40 displays an image. More specifically, the display 40 displays an image captured by a camera serving to capture an image behind the vehicle. Note that the display 40 may display not only the image captured by the camera serving to capture an image behind the vehicle but also an image captured by another camera as long as the display 40 is connected to the camera in a wired or wireless manner.

In addition, a pad 41 is disposed between the display 40 and the frame 30. The pad 41 fills a gap between the display 40 and the frame 30. With this structure, the pad 41 prevents rubbish such as dust or dirt from entering the electronic mirror 1.

The display 40 includes a display housing 42, a polarization reflection layer 43, the LCD cell 44, and a display control unit 46. The display housing 42 is a housing covering the display 40.

The polarization reflection layer 43 is disposed between the cover lens 10 and the display 40 and on a surface 441 of the display 40. In addition, the polarization reflection layer 43 reflects part of light incident through the cover lens 10 and transmits light of an image displayed by the display 40. The polarization reflection layer 43 is an example of a polarization reflection unit. The polarization reflection layer 43 reflects light as a mirror in the mirror mode, and transmits light of an image displayed by the display 40 toward a front side in the display mode.

More specifically, the polarization reflection layer 43 transmits light polarized in a specific direction and reflects light in a direction different from the specific direction. In addition, the polarization reflection layer 43 transmits light emitted from the LCD cell 44. The polarization reflection layer 43 is attached to the surface 441 of the display 40 with a transparent adhesive 45 such as an optical clear adhesive (OCA). Specifically, the polarization reflection layer 43 is attached to the surface 441 of the LCD cell 44.

The LCD cell 44 is a member that a liquid crystal is injected between glass substrates. The display 40 displays an image by emitting light through the LCD cell 44.

The display control unit 46 controls the display 40. The display control unit 46 includes, for example, a circuit board that controls the display 40, a backlight that emits light to the LCD cell 44, and a reception unit that receives an image from a camera mounted on the vehicle. In the display mode, the display control unit 46 causes the LCD cell 44 to display an image captured by a camera mounted on the vehicle.

The housing 50 houses the display 40 and is attached to the vehicle. The housing 50 includes a housing unit 51, an arm unit 52 (an example of an arm member), and an attachment unit 53 (an example of an attachment member). The housing unit 51 is a housing that houses the display 40. In addition, the housing unit 51 has the protrusion 54 on a front side. The protrusion 54 is inserted into the recess part 33 formed in the joint part 32 of the frame 30. With this structure, the housing unit 51 of the housing 50 is joined to the frame 30. The housing 50 and the frame 30 are housings covering the periphery of the display 40. The housing 50 and the frame 30 are examples of a housing.

The arm unit 52 is an arm-shaped member that connects the housing 50 and the attachment unit 53 to each other. In addition, the arm unit 52 may include a joint to change an angle of the display 40. With this structure, a user can adjust an angle of the electronic mirror 1 to an angle at which the electronic mirror 1 can be easily seen. For example, the angle of the electronic mirror 1 can be changed between the display mode and the mirror mode.

The attachment unit 53 is a member attached to the interior of the vehicle. For example, the attachment unit 53 is attached to a ceiling or a windshield of the vehicle. In this manner, the electronic mirror 1 is attached to the vehicle.

As described above, the electronic mirror 1 according to the first embodiment includes the cover lens 10 that transmits visible light, the display 40 that displays an image, and the polarization reflection layer 43 disposed in the LCD cell 44 of the display 40. The polarization reflection layer 43 reflects light incident through the cover lens 10 and polarizes light of an image displayed on the LCD cell 44. Thus, the polarization reflection layer 43 also functions as a polarization plate that polarizes light of an image displayed on the LCD cell 44. Therefore, the electronic mirror 1 can resolve the overlap of roles among plural structural members.

Moreover, in the electronic mirror 1, the polarization reflection layer 43 is disposed in the LCD cell 44. With this structure, the cover lens 10 can be made from resin that is lighter than glass. The resin is softer than glass and is easily deformed. Thus, if the polarization reflection layer is disposed in the cover lens made from resin, it is difficult to maintain the flatness of the polarization reflection layer, and there is a problem that a reflected image is distorted. In the electronic mirror 1 according to the first embodiment, the polarization reflection layer 43 is disposed in the LCD cell 44 having high hardness. Therefore, the flatness of the polarization reflection layer 43 in the electronic mirror 1 can be maintained, and distortion of a reflected image can be suppressed.

In addition, as illustrated in FIG. 3, the cover lens 10 is attached to a front side of the frame 30. The frame 30 may be provided with a fringe that covers an edge of the cover lens 10. In some countries or regions, laws and regulations may require the edge of the cover lens 10 to be covered by a fringe. Therefore, even in such countries or regions, the electronic mirror 1 with the above-mentioned fringe can be used.

### Second Embodiment

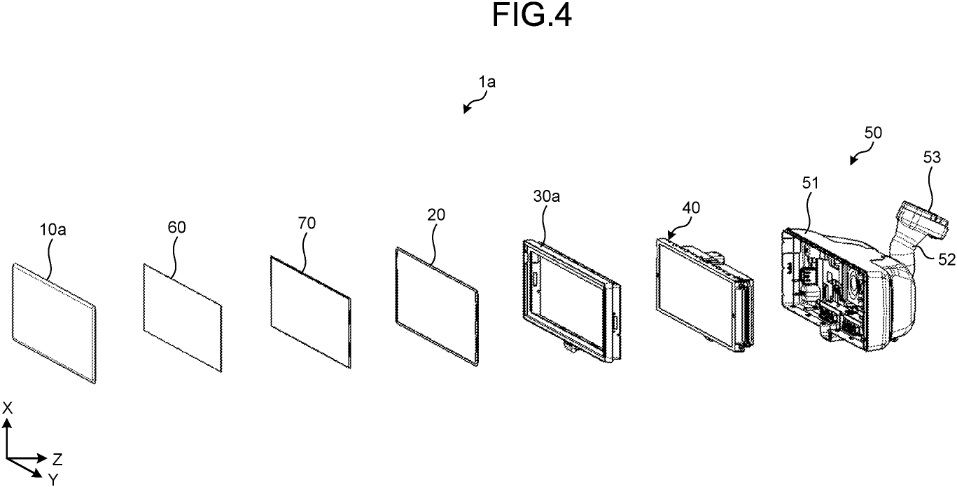

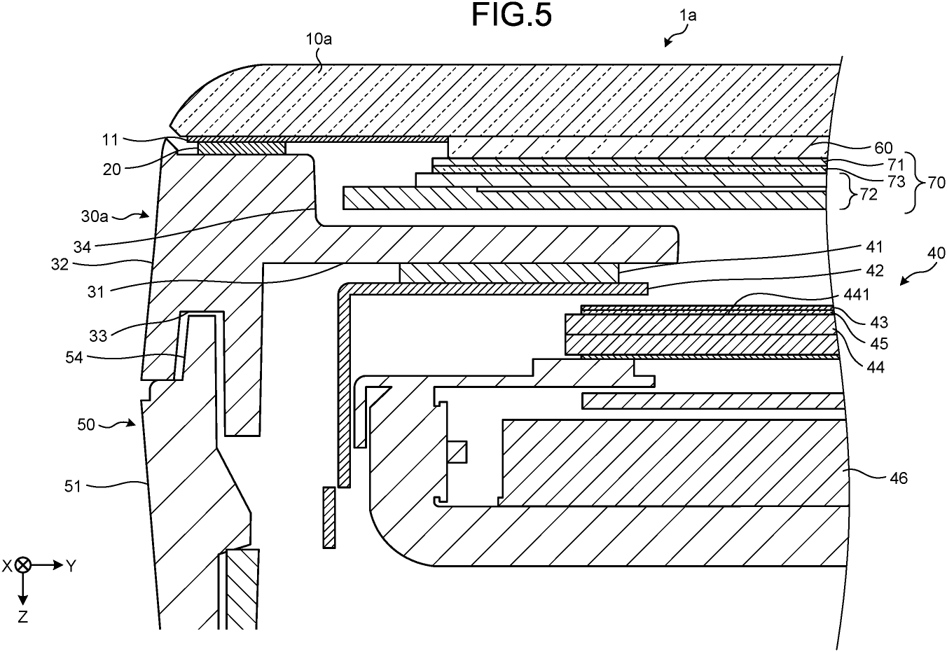

FIG. 4 is an exploded perspective view illustrating an example of an electronic mirror 1a according to a second embodiment. FIG. 5 is a cross-sectional view of the electronic mirror 1a according to the second embodiment. Note that a front of the electronic mirror 1a according to the second embodiment is substantially the same as that of the electronic mirror 1 according to the first embodiment illustrated in FIG. 1. Thus, a front view is omitted.

As illustrated in FIG. 4, the electronic mirror 1a includes a cover lens 10a, an OCA 60, a variable reflectance mirror (VRM) 70, a double-sided tape 20, a frame 30a, a display 40, and a housing 50.

The electronic mirror 1a includes the VRM 70 that functions as a mirror in the mirror mode. A mirror layer 11 that projects an image, like a mirror does, is disposed in a region from an edge of the cover lens 10a to a position where the VRM 70 is disposed in the cover lens 10a. In the example illustrated in FIG. 5, when the electronic mirror 1a is viewed from a front, the mirror layer 11 is disposed outside a position where the VRM 70 is disposed.

The OCA 60 is a transparent adhesive that causes the cover lens 10a and the VRM 70 to adhere to each other.

The VRM 70 changes reflectance and transmittance of incident light in accordance with an applied voltage. For example, the VRM 70 increases the transmittance of incident light in the display mode. In this mode, the VRM 70 transmits light of an image displayed by the display 40 disposed on a rear side of the VRM 70. Meanwhile, the VRM 70 increases the reflectance of incident light in the mirror mode. In this mode, the VRM 70 reflects light incident through the cover lens 10a.

The VRM 70 includes a polarization unit 71 (an example of a polarization element), a twisted nematic (TN) liquid crystal unit 72, and an adhesive 73. The polarization reflection layer 43 disposed on a surface 441 of an LCD cell 44 functions as part of the VRM 70.

The polarization unit 71 is disposed between the cover lens 10a and the polarization reflection layer 43 and on the cover lens 10a side. The polarization unit 71 polarizes light incident through the cover lens 10a. More specifically, the polarization unit 71 is a polarization plate that transmits a light beam polarized in a specific direction out of light beams incident through the cover lens 10a. In addition, the polarization unit 71 absorbs light in a direction different from the above-mentioned specific direction.

The TN liquid crystal unit 72 is a TN type liquid crystal panel. The TN liquid crystal unit 72 is located between the polarization unit 71 and the polarization reflection layer 43. The TN liquid crystal unit 72 changes a polarization direction of light incident through the polarization unit 71. The TN liquid crystal unit 72 is an example of a liquid crystal unit. More specifically, the TN liquid crystal unit 72 changes the alignment of molecules of a liquid crystal material to be in line with a perpendicular direction when a voltage is applied. With this function, the TN liquid crystal unit 72 causes light passing through the TN liquid crystal unit 72 to go straight. Meanwhile, the TN liquid crystal unit 72 does not change the alignment of molecules of a liquid crystal material when no voltage is applied. With this function, the TN liquid crystal unit 72 changes a polarization direction of light that passes through the TN liquid crystal unit 72. For example, the TN liquid crystal unit 72 twists a polarization direction of light by 90 degrees. An example of the liquid crystal unit is not limited thereto. For example, the liquid crystal unit may be a liquid crystal unit that changes a polarization direction of light that passes through the TN liquid crystal unit 72 when a voltage is applied, and causes light that passes through the TN liquid crystal unit 72 to go straight when no voltage is applied.

In addition, the TN liquid crystal unit 72 is attached to the polarization unit 71 by the adhesive 73. As the adhesive 73, a transparent OCA or the like can be used similarly to the adhesive 45.

The polarization reflection layer 43 transmits light in the same direction as the polarization unit 71. In other words, the polarization reflection layer 43 transmits light that has gone straight out the TN liquid crystal unit 72. In addition, the polarization reflection layer 43 reflects light whose polarization direction has been changed by the TN liquid crystal unit 72. As a result, the polarization reflection layer 43 reflects part of light incident through the TN liquid crystal unit 72 and transmits light of an image displayed by the display 40.

In such a configuration described above, the polarization reflection layer 43 transmits a light beam polarized in a specific direction among light beams of an image displayed by the LCD cell 44 in the display mode. In addition, a voltage is applied to the VRM 70 in the display mode. Therefore, the TN liquid crystal unit 72 causes light incident from the polarization reflection layer 43 to go straight without changing a polarization direction of the light. In addition, light that has passed through the TN liquid crystal unit 72 passes through the polarization unit 71. Then, the light that has passed through the polarization unit 71 is emitted through the OCA 60 and the cover lens 10a. As a result, the electronic mirror 1a displays an image.

On the other hand, in the mirror mode, no voltage is applied to the TN liquid crystal unit 72. In this mode, the TN liquid crystal unit 72 changes a polarization direction of light incident from the polarization unit 71 by molecules of a liquid crystal material. Then, the polarization reflection layer 43 reflects light whose polarization direction has been changed by the TN liquid crystal unit 72.

The TN liquid crystal unit 72 changes a polarization direction of light reflected by the polarization reflection layer 43. As a result, the angle of light that has passed through the TN liquid crystal unit 72 returns to an angle when the light passes through the polarization unit 71. Then, the light that has passed through the TN liquid crystal unit 72 passes through the polarization unit 71. The light that has passed through the polarization unit 71 is emitted through the OCA 60 and the cover lens 10a. In this way, the electronic mirror 1a reflects light in the mirror mode.

As illustrated in FIG. 5, the TN liquid crystal unit 72 and the polarization unit 71 are disposed between the cover lens 10a and the frame 30a. The frame 30a has a stepped shape in order to form a space where the TN liquid crystal unit 72 and the polarization unit 71 are disposed. The frame 30a includes a disposition unit 34 that the TN liquid crystal unit 72 and the polarization unit 71 are disposed at a position one step lower than a surface bonded to the cover lens 10a by the double-sided tape 20. The display 40 is disposed on a rear side of the disposition unit 34.

As described above, the electronic mirror 1a according to the second embodiment includes the polarization unit 71 and the TN liquid crystal unit 72. The polarization unit 71 is disposed between the cover lens 10a and the polarization reflection layer 43 and polarizes light incident through the cover lens 10a. The TN liquid crystal unit 72 changes a polarization direction of light incident through the polarization unit 71. In addition, the polarization reflection layer 43 disposed on the LCD cell 44 of the display 40 also functions as a polarization reflection plate of the VRM 70. Therefore, the electronic mirror 1a can resolve the overlap of roles among plural structural members.

Moreover, as illustrated in FIG. 5, the cover lens 10a is attached to a front side of frame 30a. The frame 30a may be provided with a fringe that covers an edge of the cover lens 10a. In some countries or regions, laws and regulations may require the edge of the cover lens 10a to be covered by a fringe. Therefore, even in such countries or regions, the electronic mirror 1a with the above-mentioned fringe can be used.

### Third Embodiment

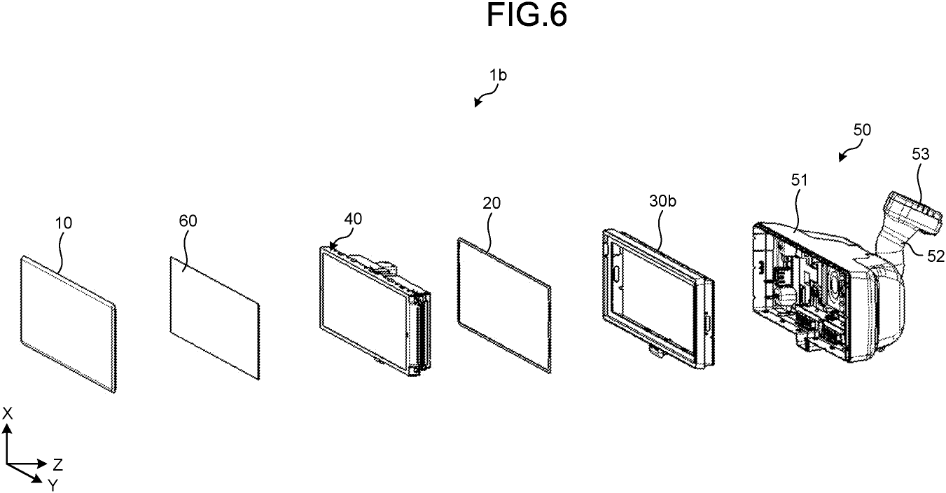

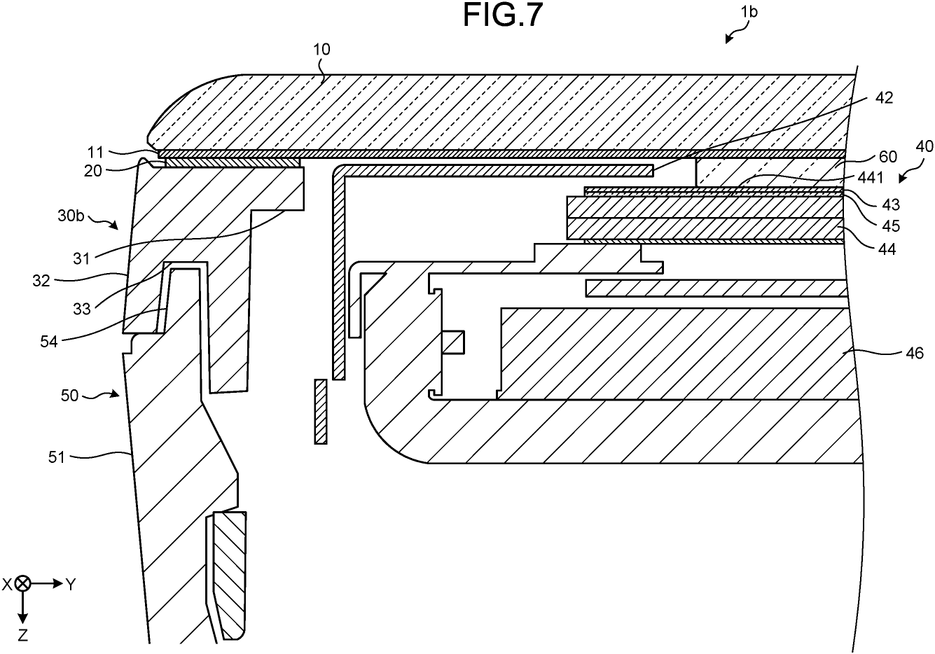

FIG. 6 is an exploded perspective view illustrating an example of an electronic mirror 1b according to a third embodiment. FIG. 7 is a cross-sectional view of the electronic mirror 1b according to the third embodiment. Note that a front of the electronic mirror 1b according to the third embodiment is substantially the same as that of the electronic mirror 1 according to the first embodiment illustrated in FIG. 1. Thus, a front view is omitted.

As illustrated in FIG. 6, the electronic mirror 1b includes a cover lens 10, an OCA 60, a display 40, a double-sided tape 20, a frame 30b, and a housing 50.

The OCA 60 is a transparent adhesive. The cover lens 10 and the display 40 are adhered to each other by the OCA 60. More specifically, the OCA 60 bonds the cover lens 10 and a polarization reflection layer 43 formed on a surface 441 of an LCD cell 44 to each other. In other words, the cover lens 10 and the display 40 are bonded to each other by the OCA 60. Therefore, as illustrated in FIG. 7, the frame 30b has no outer frame that covers an edge of display 40.

The display 40 is bonded to the cover lens 10 by the OCA 60. In addition, the display 40 includes the LCD cell 44 that displays an image captured by a camera mounted on a vehicle. In addition, the LCD cell 44 includes the polarization reflection layer 43 on the surface 441 on a front side.

As described above, in the electronic mirror 1b according to the third embodiment, the cover lens 10 and the LCD cell 44 in which the polarization reflection layer 43 is disposed are bonded to each other by the OCA 60. Also in this case, the polarization reflection layer 43 reflects light incident through the cover lens 10 and polarizes light of an image displayed on the LCD cell 44. That is, the polarization reflection layer 43 also functions as a polarization plate that polarizes light of an image displayed on the LCD cell 44. Therefore, the electronic mirror 1b can resolve the overlap of roles among plural structural members.

In addition, as illustrated in FIG. 7, the cover lens 10 is attached to a front side of the frame 30b. The frame 30b may be provided with a fringe that covers an edge of the cover lens 10. In some countries or regions, laws and regulations may require the edge of the cover lens 10 to be covered by a fringe. Therefore, even in such countries or regions, the electronic mirror 1b with the above-mentioned fringe can be used.

### Fourth Embodiment

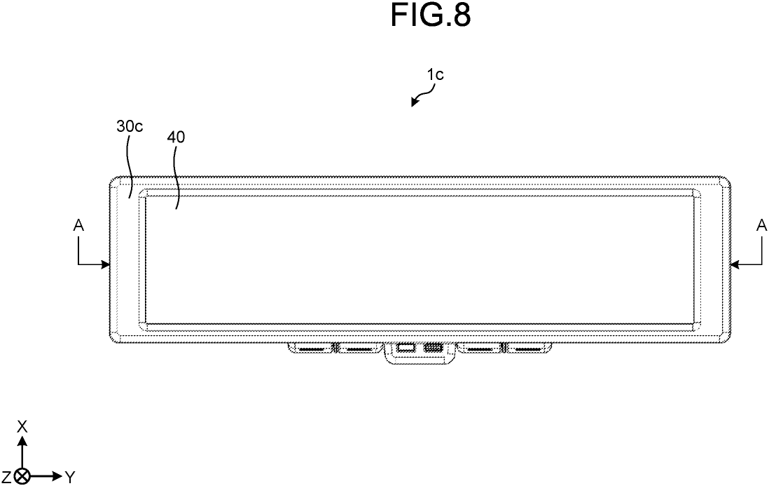

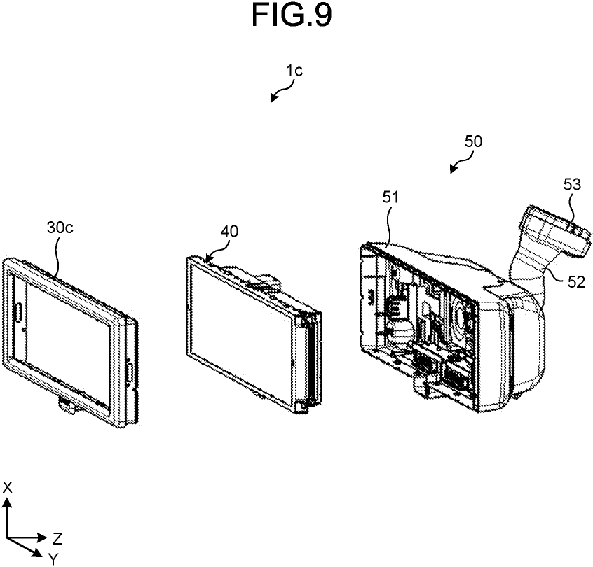

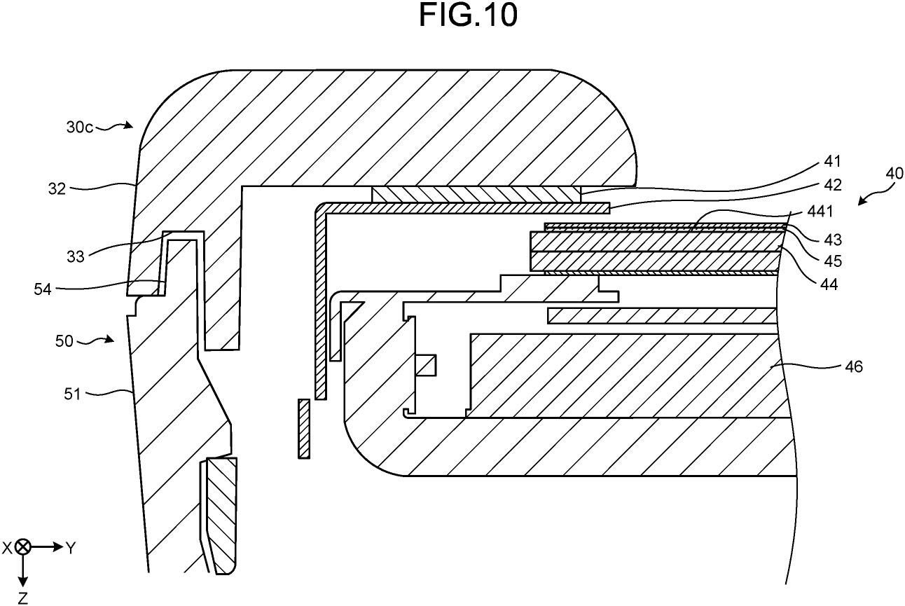

FIG. 8 is a front view illustrating an example of an electronic mirror 1c according to a fourth embodiment. FIG. 9 is an exploded perspective view illustrating an example of the electronic mirror 1c according to the fourth embodiment. FIG. 10 is a cross-sectional view of A-A for the electronic mirror 1c illustrated in FIG. 8.

The electronic mirror 1c according to the fourth embodiment does not include the cover lens 10 or the double-sided tape 20 of the electronic mirror 1. That is, as illustrated in FIG. 9, the electronic mirror 1c includes a frame 30c, a display 40, and a housing 50.

As illustrated in FIG. 10, the electronic mirror 1c includes no cover lens 10, so that the display 40 is exposed. More specifically, in the electronic mirror 1c, a polarization reflection layer 43 disposed on a surface 441 of an LCD cell 44 is exposed. The polarization reflection layer 43 is disposed on the surface 441 of the display 40. The polarization reflection layer 43 reflects part of light incident from an opposite side of the display 40 and transmits light of an image displayed by the display 40.

In addition, the cover lens 10 is not disposed, so that the frame 30c serves as an outer frame of the display 40. Therefore, the frame 30c has a curved appearance.

As described above, the electronic mirror 1c according to the fourth embodiment does not include the cover lens 10. Even with this configuration, the polarization reflection layer 43 reflects incident light and polarizes light of an image displayed on the LCD cell 44. That is, the polarization reflection layer 43 also functions as a polarization plate that polarizes light of an image displayed on the LCD cell 44. Therefore, the electronic mirror 1c can resolve the overlap of roles among plural structural members.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The present disclosure can provide a display device and an in-vehicle display device capable of resolving the overlap of roles among plural structural members.

What is claimed is:

1. A display device comprising:
a cover configured to transmit visible light;
a display configured to display an image; and
a polarization reflection layer disposed between the cover and the display and on a surface of the display, the polarization reflection layer being configured to reflect part of light incident through the cover and transmit light of the image displayed by the display.

2. The display device according to claim 1, further comprising:
a polarization element disposed between the cover and the polarization reflection layer and on the cover side, the polarization element being configured to polarize light incident through the cover; and
a liquid crystal panel located between the polarization element and the polarization reflection layer, the liquid crystal panel being configured to change a polarization direction of light incident through the polarization element,
wherein the polarization reflection layer is configured to reflect part of light incident through the liquid crystal panel and transmit light of the image displayed by the display.

3. The display device according to claim 1, wherein the cover and the polarization reflection layer are adhered to each other.

4. The display device according to claim 1, further comprising a frame configured to support the cover,
wherein the cover includes a mirror layer configured to project an image by reflecting visible light, the image being projected at a position corresponding to the frame.

5. The display device according to claim 1, wherein the display is configured to display the image captured by a camera serving to capture an image behind a vehicle.

6. The display device according to claim 1, wherein the cover is made from resin.

7. An in-vehicle display device comprising:
a display configured to display an image captured by a camera serving to capture an image behind a vehicle;
a polarization reflection layer disposed on a surface of the display, the polarization reflection layer being configured to reflect part of light incident from an opposite side of the display and transmit light of the image displayed by the display;
a housing configured to cover the periphery of the display; and
an attachment member attached to an interior of the vehicle.

8. The in-vehicle display device according to claim 7, further comprising an arm member configured to change an angle of the display.
